(19) United States
(12) Patent Application Publication
(10) Pub. No.: US 2008/0303753 A1
(43) Pub. Date: Dec. 11, 2008

(54) Display apparatus

(76) Inventors: Cha-Won Hwang, Suwon-si (KR); Sung-Yong Lee, Suwon-si (KR); Ji-Suk Kim, Suwon-si (KR); Sang-Mi Lee, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/157,005

(22) Filed: Jun. 5, 2008

(30) Foreign Application Priority Data
Jun. 7, 2007 (KR) 10-2007-0055719

(51) Int. Cl. G09G 3/28

(52) U.S. Cl. 345/60

(57) ABSTRACT

Provided is a display apparatus that includes a panel assembly which has a plurality of substrates and displays images, and a filter assembly which is formed in front of the panel assembly, has a base film, a refraction control film layer that is attached to at least a surface of the base film and has a refractive index different from that of the base film, and an optical absorption layer that is formed on an outer surface of the base film or the refraction control film layer to absorb refracted incident external light. The display apparatus can increase bright room contrast by absorbing incident external light by employing a film coated with a black group color on a front surface of a panel. Also, a direct attachable filter assembly is used to remove an interface between the substrate and the filter assembly. Thus, a double image problem caused by refraction of light at the interface is prevented.

### CROSS-REFERENCE TO RELATED PATENT APPLICATION

This application claims the benefit of Korean Patent Application No. 10-2007-0055719, filed on Jun. 7, 2007, in the Korean Intellectual Property Office, the disclosure of which is incorporated herein in its entirety by reference.

### BACKGROUND OF THE INVENTION

1. Field of the Invention

The present embodiments relate to a display apparatus, and more particularly, to a display apparatus having increased optical efficiency through a modified filter assembly structure.

2. Description of the Related Art

A plasma display panel is a flat display device that displays desired images such as numbers, letters, or graphics using visible light emitted from phosphor material layers formed in discharge spaces. When a discharge gas is filled between a plurality of substrates on which a plurality of discharge electrodes are formed and a discharge voltage is applied to the discharge electrodes, the phosphor material layers are excited by ultraviolet rays generated from the discharge gas, thereby emitting visible light.

Plasma display panels are classified into a direct current (DC) type and an alternating current (AC) type according to the type of a driving voltage applied to the discharge cells, for example, the type of a discharge, and can also be classified into a facing discharge type and a surface discharge type according to the configuration of discharge electrodes.

FIG. 1 is a cross-sectional view of a plasma display panel 100. Referring to FIG. 1, the plasma display panel 100 includes a panel assembly 101, a chassis base 102 installed on a rear side of the panel assembly 101, a driving circuit board 105 installed on a rear side of the chassis base 102, a filter assembly 103 installed in front of the panel assembly 101, and a case 104 that accommodates the panel assembly 101, the chassis base 102, the filter assembly 103, and the driving circuit board 105.

The plasma display panel 100 generates electromagnetic waves, infrared rays, and neon light with a wavelength of approximately 590 nm during driving. The filter assembly 103 is formed to block the electromagnetic waves, infrared rays, and neon light. The filter assembly 103 is formed by attaching a reflection preventive film or an electromagnetic wave shielding film on a thick glass substrate or a thick plastic substrate, and is combined to the case 104 using a supporting member such as a filter holder. At this point, the filter assembly 103 is grounded by being connected to a chassis portion of the case 104 through a conductive line 106.

However, since the filter assembly 103 is formed using a thick glass substrate or a thick plastic substrate, there is a problem of double reflection of an image between a substrate of the panel assembly 101 and the substrate of the filter assembly 103 due to light refraction.

Also, the substrate of the filter assembly 103 is formed to a thickness of approximately 3 mm so that the substrate can resist an external impact. Accordingly, the substrate is quite heavy and includes a relatively large number of parts, thereby increasing the manufacturing costs and having complicated assembly processes.

FIG. 2 is a cross-sectional view of a filter assembly 200. In order to solve the above problems, the filter assembly 200 is manufactured without a thick glass substrate or a thick plastic substrate. That is, the filter assembly 200 includes a first base film 201, a second base film 202, a third base film 203, a reflection preventive layer 204 in front of the first base film 201, a color compensation layer 206 attached by a first adhesive 205 between the first base film 201 and the second base film 202, an electromagnetic wave blocking filter 208 attached to a second adhesive 207 between the second base film 202 and the third base film 203, and a third adhesive 209 for attaching a substrate (not shown) of a panel assembly to a rear surface of the third base film 203.

However, the filter assembly 200 requires a plurality of films such as the first film 201 through third film 203, and other films having various functions must be attached to the first through third films 201 through 203. Thus, the filter assembly 200 has increased manufacturing costs and complicated manufacturing processes.

Furthermore, there is a limit in increasing the optical efficiency of the filter assembly 200 since the filter assembly 200 has almost the same optical transmittance of light incident from the outside and internal light generated from the panel.

### SUMMARY OF THE INVENTION

The present embodiments provide a display apparatus having an improved filter assembly structure that can increase the transmittance of internal light and bright room contrast by blocking external light.

According to an aspect of the present embodiments, there is provided a display apparatus comprising: a panel assembly which has a plurality of substrates and displays images; and a filter assembly which is formed in front of the panel assembly, has a base film, a refraction control film layer that is attached to at least a surface of the base film and has a refractive index different from that of the base film, and an optical absorption layer that is formed on an outer surface of the base film or the refraction control film layer to absorb refracted incident external light.

The filter assembly may be directly surface-contacted the front surface of the substrate.

The display apparatus may further comprise an optical reflection layer on an outer surface of the optical absorption layer.

A first refraction control film layer may be formed on a surface of the base film and a first optical absorption layer may be formed on an outer surface of the first refraction control film layer. A second optical absorption layer may be formed on other surface of the base film and an optical reflection layer may be formed on an outer surface of the second optical absorption layer.

The display apparatus may further comprise a reflective reduction film that is attached on the base film by an adhesive.

The base film may further comprise an electromagnetic wave shielding filter.

### BRIEF DESCRIPTION OF THE DRAWINGS

The above and other features and advantages of the present embodiments will become more apparent by describing in detail exemplary embodiments thereof with reference to the attached drawings in which:

FIG. 1 is a schematic cross-sectional view of a conventional display apparatus;

FIG. 2 is a cross-sectional view of a conventional filter assembly;

FIG. 3 is an exploded perspective view illustrating a plasma display panel of a display apparatus according to an embodiment;

FIG. 4 is an enlarged cross-sectional view of a portion of the display apparatus of FIG. 3, according to an embodiment;

FIG. 5 is a cross-sectional view illustrating a filter assembly according to an embodiment ion;

FIG. 6 is a cross-sectional view illustrating a filter assembly according to another embodiment;

FIG. 7 is a cross-sectional view illustrating a filter assembly according to another embodiment;

FIG. 8 is a cross-sectional view illustrating a filter assembly according to another embodiment; and

FIG. 9 is a cross-sectional view illustrating a filter assembly according to another embodiment.

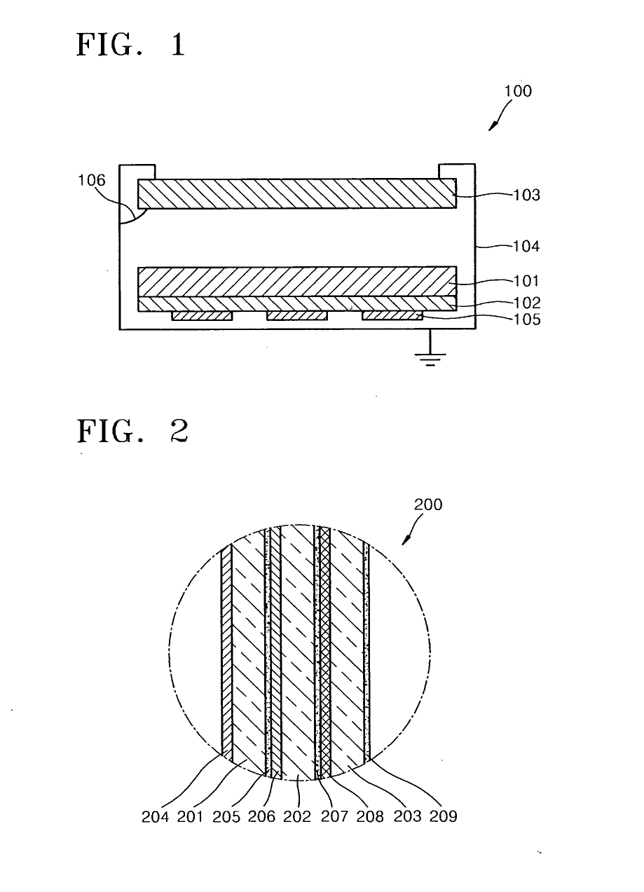

### DETAILED DESCRIPTION OF THE INVENTION

The present embodiments will now be described more fully with reference to the accompanying drawings in which exemplary embodiments are shown.

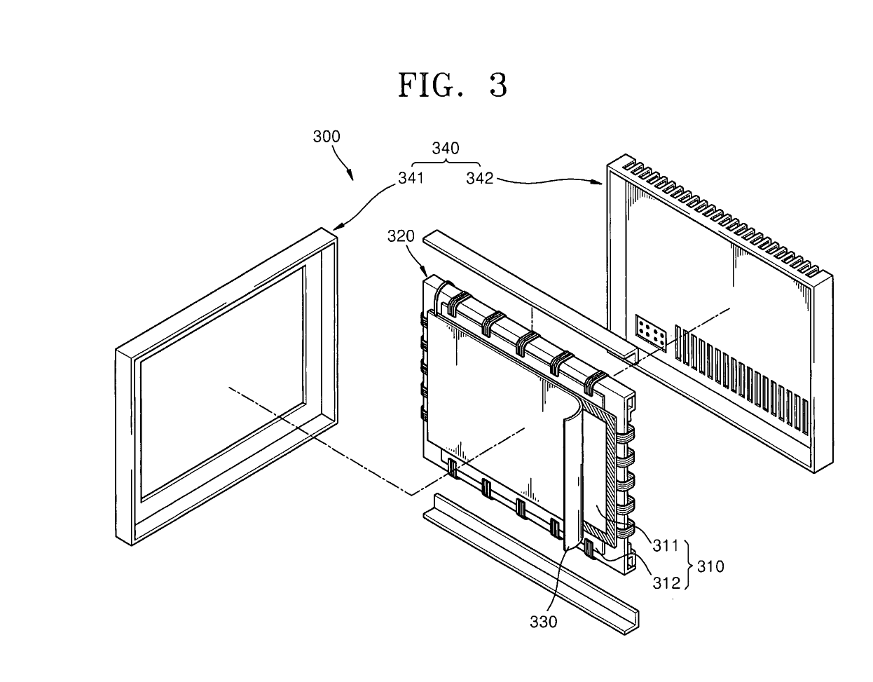

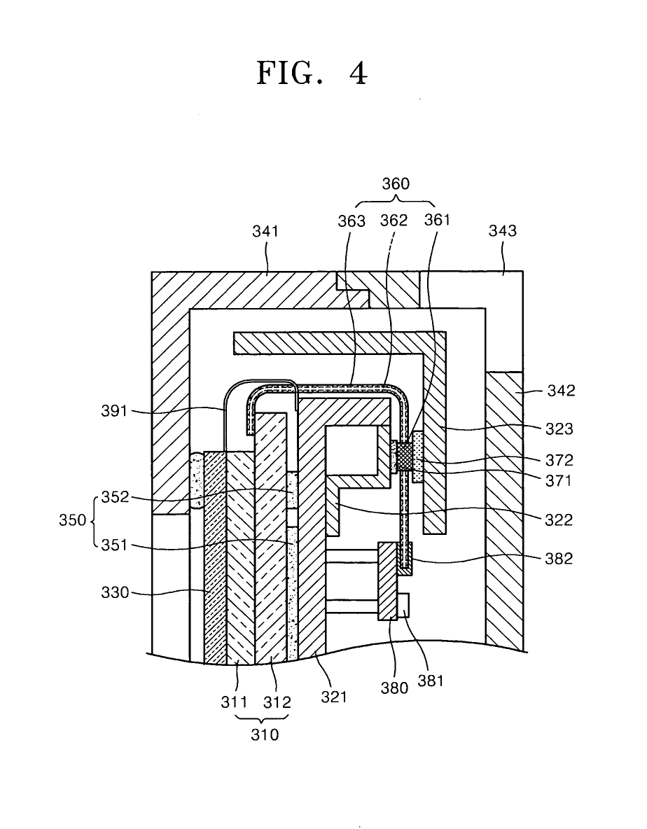

FIG. 3 is an exploded perspective view illustrating a plasma display panel 300 of a display apparatus according to an embodiment, and FIG. 4 is a partial enlarged cross-sectional view of the coupled plasma display panel 300 of FIG. 3.

Referring to FIGS. 3 and 4, the plasma display panel 300 includes a panel assembly 310, a chassis base assembly 320 combined on a rear side of the panel assembly 310, a filter assembly 330 attached to a front surface of the panel assembly 310, and a case that accommodates the panel assembly 310, the chassis base assembly 320, and the filter assembly 330.

The panel assembly 310 includes a first substrate 311 and a second substrate 312 coupled to the first substrate 311. A sealant (not shown) is coated on inner edge surfaces of the first substrate 311 and the second substrate 312 facing each other to seal an inner space therebetween.

The chassis base assembly 320 is combined on a rear side of the panel assembly 310. For example, a chassis base 321 is attached to the rear surface of the second substrate 312 using an adhesive member 350.

The adhesive member 350 includes a thermal conductive sheet 351 and dual sided tape 352. The thermal conductive sheet 351 is attached to the rear center of the second substrate 312, and is a thermal conductive medium that transmits heat generated during the driving of the panel assembly 310 to the chassis base 321. The dual sided tape 352 is attached along edges of the rear surface of the second substrate 312 and fixes the chassis base 321 to the second substrate 312.

A plurality of driving circuit boards 380 are installed on the rear surface of the chassis base 321. Each of the driving circuit boards 380 includes a plurality of circuit devices 381. A signal transmit unit 360 such as a flexible printed cable is disposed on an end rear of the chassis base 321.

An end of the signal transmit unit 360 is electrically connected to a connector 382 mounted on the driving circuit boards 380, and other end of the signal transmit unit 360 is connected to discharge electrode terminals of the panel assembly 310. The signal transmit unit 360 transmits electrical signals between the panel assembly 310 and the driving circuit boards 380.

The signal transmit unit 360 includes a driving integrated circuit (IC) 361, a plurality of leads 362 electrically connected to the driving IC 361, and a flexible film 363 that buries the leads 362.

Chassis reinforcing members 322 for reinforcing the strength of the chassis base 321 are attached to upper and lower parts of the rear surface of the chassis base 321. Cover plates 323 for preventing damages to the signal transmit unit 360 are installed on upper and lower parts of rear of the chassis base 321.

The signal transmit unit 360 is disposed in a space between the chassis base 321 and the cover plate 323, and a thermal grease 371 is interposed between the driving IC 361 and the chassis reinforcing member 322. A silicon layer 372 is formed between the driving IC and the cover plate 323.

The filter assembly 330 is attached to a front surface of the first substrate 311. The filter assembly 330 is formed by stacking a plurality of films to block electromagnetic waves, infrared rays, neon light, or the reflection of external light.

The panel assembly 310, the chassis base assembly 320, and the filter assembly 330 are accommodated in the case 340. The case 340 includes a front cabinet 341 installed in front of the filter assembly 330 and a back cover 342 installed on the rear of the chassis base assembly 320. A plurality of holes 343 are formed in upper and lower parts of the back cover 342.

The filter assembly 330 is directly attached to the front surface of the panel assembly 310, and is formed by stacking a plurality of films to increase bright room contrast of the plasma display panel 300.

The filter assembly 330 will now be described in detail.

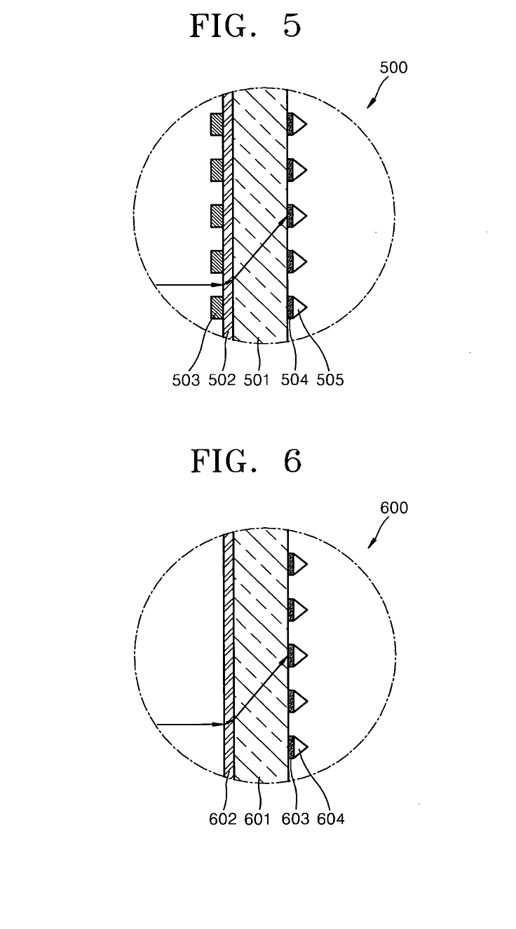

FIG. 5 is a cross-sectional view illustrating a filter assembly 500 according to an embodiment.

Referring to FIG. 5, the filter assembly 500 includes a base film 501 formed of a polymer resin for example, Polyethersulfone (PES), Polyacrylate (PAC), Polyetherimides (PEI), Polyethylene Naphthalate (PEN), Polyethylene Terephthalate (PET), Polyphenylene Sulfide (PPS), Polyimide (PI), Polycarbonate (PC), Cellulous Triacetate (TAC) or Cellulose Acetate Propionate (CAP). A refraction control film layer 502 is formed on a front surface of the base film 501, and formed of inorganic oxide particles for example, TiO₂, ZnS, Sb₂O₃, ZnO₂, indium tin oxide (ITO), antimony tin oxide (ATO), titanium antimony tin oxide (TATO), CeO, SeO₂, Al₂O₃, Y₂O₃, and antimony zinc oxide (AZO). The refraction control film layer 502 has a refractive index different from the base film 501. That is, the base film 501 has a refractive index of 1.6 to 1.64, and the refraction control film layer 502 has a refractive index of from about 1.3 to about 1.7.

A first optical absorption layer 503 is patterned on a front surface of the refraction control film layer 502. The first optical absorption layer 503 is formed in a stripe shape using a black group material such as black enamel so that incident light can be absorbed. The surface where the first optical absorption layer 503 is formed is a surface through which light enters.

A second optical absorption layer 504 is patterned on a rear surface of the base film 501. The second optical absorption layer 504 is formed of substantially the same material as the first optical absorption layer 503. Alternatively, the second optical absorption layer 504 can be formed of a different material as long as it is formed of a black group material. The second optical absorption layer 504 additionally absorbs incident light refracted through the refraction control film layer 502 and the base film 501 without being absorbed by the first optical absorption layer 503. The second optical absorption layer 504 is formed in a stripe shape.

At this point, the location relationship between the first optical absorption layer 503 and the second optical absorption layer 504 is not specifically limited as long as the second optical absorption layer 504 is located in a position where it can absorb incident light refracted through the first optical absorption layer 503. That is, the location combinations of the first optical absorption layer 503 and the second optical absorption layer 504 are unlimited.

An optical reflection layer 505 is formed on a surface of the second optical absorption layer 504. The optical reflection layer 505 is formed of a material having a refractive index of about 90% or above, for example, a metal such as Al, Ag, or Cu, or a metal oxide such as ITO, TiO₂, or Al₂O₃.

The optical reflection layer 505 is formed to prevent visible light from being absorbed by the second optical absorption layer 504 when the visible light is generated during the operation of the plasma display panel 300. The optical reflection layer 505 is formed is on a surface that faces the front surface of the panel assembly 310 on which images are displayed.

The surface on which the second optical absorption layer 504 and the optical reflection layer 505 are sequentially stacked directly contacts the front surface of the panel assembly 310. Also, the filter assembly 500 maintains the optical transmittance to visible rays of from about 20 to about 90%, and may have a haze value of from about 1 to about 15%.

The filter assembly 500 having the above structure primarily absorbs incident external light by the first optical absorption layer 503. Also, the external light that is transmitted through portions where the first optical absorption layer 503 is not formed is refracted while passing through the refraction control film layer 502 and the base film 501, and the refracted external light is absorbed by the second optical absorption layer 504. Therefore, bright room contrast can be increased by minimally reducing the effect of the external light. Also, visible light generated from the panel is reflected towards the panel by the optical reflection layer 505 coated on the surface of the second optical absorption layer 504, and thus, the absorption of the visible light generated from the panel can be prevented.

FIG. 6 is cross-sectional view illustrating a filter assembly 600 according to another embodiment.

Referring to FIG. 6, the filter assembly 600 includes a base film 601. A refraction control film layer 602 having a refractive index different from the base film 601 is formed on the front surface of the base film 601. The surface where the refraction control film layer 602 is formed is a surface where external light enters. An optical absorption layer 603 for absorbing external light is formed on the rear surface of the base film 601. The optical absorption layer 603 is a black layer having a particular pattern, for example, a stripe pattern. An optical reflection layer 604 is formed on a surface of the optical absorption layer 603.

In the filter assembly 600 having the above structure, light refraction occurs when light passes through the refraction control film layer 602 and the base film 601, which have different refractive indexes from each other, and the refracted external light is absorbed by the optical absorption layer 603, thereby increasing bright room contrast.

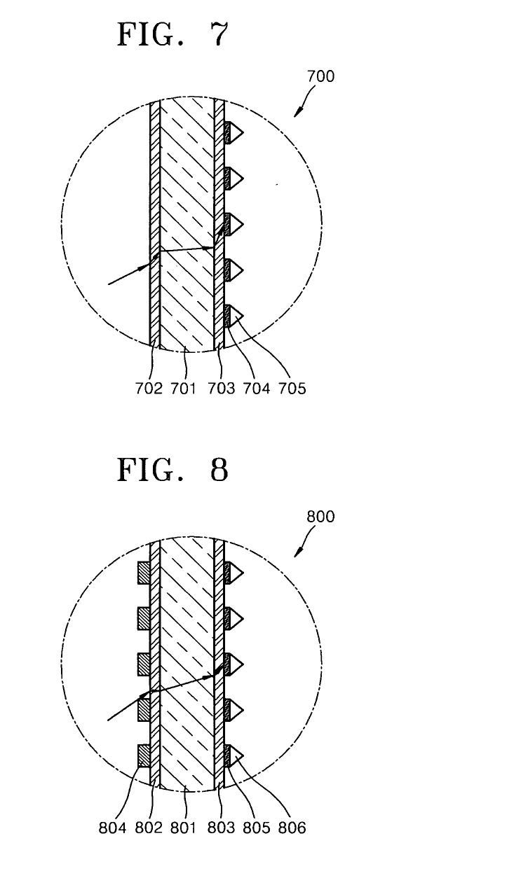

FIG. 7 is a cross-sectional view illustrating a filter assembly 700 according to another embodiment.

Referring to FIG. 7, the filter assembly 700 includes a base film 701. A first refraction control film layer 702 and a second refraction control film layer 703 are respectively formed on front and rear surfaces of the base film 701. The first and second refraction control film layer 702 and 703 are substantially formed of the same material, but are not limited thereto. That is, the first and second refraction control film layer 702 and 703 can be any refraction control film layer that can control an optical path.

An optical absorption layer 704 is formed on a surface of the second refraction control film layer 703. The optical absorption layer 704 is a black group material layer having a specific pattern, for example, a stripe shape. An optical reflection layer 705 is formed on a surface of the optical absorption layer 704.

The first refraction control film layer 702 is formed on a surface through which external light enters, and the second refraction control film layer 703, the optical absorption layer 704, and the optical reflection layer 705 are formed on a surface that is directly attached to the panel assembly.

In the filter assembly 700 having the above structure, incident external light is refracted in a multistage manner while passing through the first refraction control film layer 702, the base film 701, and the second refraction control film layer 703, and the refracted external light is absorbed by the optical absorption layer 704. At the same time, visible light generated from an inner side of the panel is not absorbed by the optical absorption layer 704 but reflected towards the inner side of the panel by the optical reflection layer 705, thereby increasing bright room contrast.

FIG. 8 is a cross-sectional view illustrating a filter assembly 800 according to another embodiment.

Referring to FIG. 8, the filter assembly 800 includes a base film 801. A first refraction control film layer 802 and a second refraction control film layer 803 are respectively formed on front and rear surfaces of the base film 801. The first and second refraction control film layer 802 and 803 may be substantially formed of the same material, but are not limited thereto as long as they have different refractive indexes from the base film 801.

A first optical absorption layer 804 is formed on a front surface of the first refraction control film layer 802. The first optical absorption layer 804 is a black group layer having a particular pattern, for example, a stripe shape. A second optical absorption layer 805 is formed on a rear surface of the second refraction control film layer 803. The second optical absorption layer 805 may be substantially formed of the same material for convenience of manufacturing process. However, the second optical absorption layer 805 can be formed of any material that can absorb incident light. An optical reflection layer 806 is formed on a surface of the second optical absorption layer 805.

In the filter assembly 800 having the above structure, incident external light is primarily absorbed by the first optical absorption layer 804. The incident external light that is not absorbed in the first optical absorption layer 804 is refracted while passing through the first refraction control film layer 802, the base film 801, and the second refraction control film layer 803, and the refracted external light is absorbed by the second optical absorption layer 805.

Meanwhile, visible light generated from an inner side of the panel is not absorbed by the second optical absorption layer 805, and is reflected towards the inner side of the panel by the optical reflection layer 806.

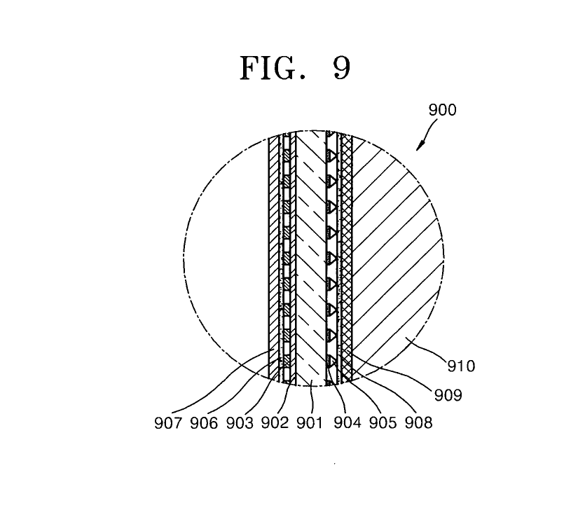

FIG. 9 is a cross-sectional view illustrating a filter assembly 900 according to another embodiment.

Referring to FIG. 9, the filter assembly 900 includes a base film 901. The base film 901 can be formed using a near infrared ray shielding film, a transmittance control film, or a selective wave absorption film.

The near infrared ray shielding film is used to form the base film 901 to shield the unnecessary light emission of near infrared rays generated due to plasma of an inert gas used for generating light for image display. The transmittance control film is used to control the amount of light transmitting through the base film 901. The selective wave absorption film that shows maximum absorption wavelengths in a from about 560 to about 610 nm region is used to shield neon light. Besides the above films, the base film 901 can include films having various functions.

A refraction control film layer 902 having a refractive index different from the base film 901 is formed on a front surface of the base film 901. A first optical absorption layer 903 is formed on a front surface of the refraction control film layer 902. The first optical absorption layer 903 having a stripe shape is formed to absorb incident external light.

A second optical absorption layer 904 is formed on a rear surface of the base film 901. The second optical absorption layer 904 absorbs the external light refracted while passing through the refraction control film layer 902 and the base film 901, and is patterned in a stripe shape like the first optical absorption layer 903. An optical reflection layer 905 for reflecting panel light generated from an inner side of the panel towards the inner side of the panel is formed on a surface of the second optical absorption layer 904.

A reflective reduction film 907 is attached to the front surface of the first optical absorption layer 903 using a first adhesive 906. The reflective reduction film 907 can be formed of at least one of an anti-glare (AG) film for preventing the reduction of visibility due to the reflection of external light and an anti-reflection (AR) film. The reflective reduction film 907 may have a thickness of from about 2 to about 7 μm, a pencil hardness of from about 2 to about 3 H, and a haze value of from about 1% to about 7%.

When the AG film is employed, the reflective reduction film 907 scatters external light since protrusions having a diameter of from about 1 nm to about 1 mm, preferably, from about 0.5 to about 20 μm, are formed on the surface of the AG film. When the AR film is employed, the effect of external light is reduced by offsetting light using a phase difference between a low refractive layer and a high refractive layer.

An electromagnetic wave shielding filter 909 is attached to a rear surface of the optical reflection layer 905 using a second adhesive 908. The rear surface of the electromagnetic wave shielding filter 909 is directly attached to a substrate 910.

The electromagnetic wave shielding filter 909 is formed to shield electromagnetic waves generated during an operation of a panel. For this purpose, the electromagnetic wave shielding filter 909 is formed of a fine metal mesh. The fine metal mesh can shield the electromagnetic waves generated during the operation of the panel. The electromagnetic wave shielding filter 909 can be formed of a material having a high electrical-conductivity such as Cu, Ag, Al, Pt, Au, Fe, or an alloy of these metals. Alternatively, the electromagnetic wave shielding filter 909 can be formed of a conductive ceramic material or carbon nanotubes.

The patterning of the metal mesh shape of the electromagnetic wave shielding filter 909 can be achieved in various ways. However, an etching method is advantageous in view of the simplicity of the manufacturing process and the standardization of patterns.

Also, other than using the metal mesh, the electromagnetic wave shielding filter 909 can be formed in various ways, for example, after a transparent conductive film such as an indium tin oxide (ITO) film is formed, an oxidized metal layer formed of a high conductive metal such as Cu can be stacked on the ITO film.

When a material that can provide color compensation, shield neon light, and shield near infrared rays is added to the first adhesive 906 or the second adhesive 908, the films described above may or may not be included.

As described above, a display apparatus according to the present embodiments provides the following advantages.

Bright room contrast of the display apparatus can be improved since external light entering through a film is absorbed by a film coated with a black group color formed on a front surface of a panel. Also, since a direct attachable filter assembly is used, an interface between a substrate and the filter assembly is removed. Thus, refraction of light at the interface is removed, thereby removing the double image problem.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A display apparatus comprising:
a panel assembly comprising a plurality of substrates and displays images; and
a filter assembly formed in front of the panel assembly comprising a base film, a refraction control film layer attached to at least a surface of the base film with a refractive index different from that of the base film, and an optical absorption layer formed on an outer surface of the base film or the refraction control film layer configured to absorb refracted incident external light.

2. The display apparatus of claim 1, wherein the filter assembly is directly surface-contacted to the front surface of the substrate.

3. The display apparatus of claim 1, wherein the filter assembly has a transmittance to visible rays of from about 20 to about 90%.

4. The display apparatus of claim 1, wherein the filter assembly has a haze value of from about 1 to about 15%.

5. The display apparatus of claim 1, wherein the optical absorption layer has a stripe shape.

6. The display apparatus of claim 1, further comprising an optical reflection layer on an outer surface of the optical absorption layer.

7. The display apparatus of claim 6, wherein the optical reflection layer is disposed between the base film and the substrate.

8. The display apparatus of claim 6, wherein
a first refraction control film layer is formed on a surface of the base film and a first optical absorption layer is formed on an outer surface of the first refraction control film layer, and
a second optical absorption layer is formed on the other surface of the base film and an optical reflection layer is formed on an outer surface of the second optical absorption layer.

9. The display apparatus of claim 6, wherein
the refraction control film layer is formed on a surface of the base film,
the optical absorption layer is formed on the other surface of the base film, and
the optical reflection layer is formed on an outer surface of the optical absorption layer.

10. The display apparatus of claim 6, wherein
the first refraction control film layer is formed on a surface of the base film,
the second refraction control film layer is formed on the other surface of the base film,
the optical absorption layer is formed on an outer surface of the second refraction control film layer, and
the optical reflection layer is formed on an outer surface of the optical absorption layer.

11. The display apparatus of claim 6, wherein
the first refraction control film layer is formed on a surface of the base film and the first optical absorption layer is formed on an outer surface of the first refraction control film layer, and
wherein the second refraction control film layer is formed on the other surface of the base film, the second optical absorption layer is formed on an outer surface of the second refraction control film layer, and the optical reflection layer is formed on an outer surface of the second optical absorption layer.

12. The display apparatus of claim 1, further comprising a reflective reduction film that is attached on the base film by an adhesive.

13. The display apparatus of claim 12, wherein the reflective reduction film has a thickness of from about 2 to about 7 μm, a pencil hardness of from about 2 to about 3 H, and a haze value of from about 1 to about 7%.

14. The display apparatus of claim 12, wherein the adhesive comprises a material that compensates color, shields neon light, or shields near infrared rays.

15. The display apparatus of claim 1, wherein the base film further comprises an electromagnetic wave shielding filter.

16. The display apparatus of claim 15, wherein the electromagnetic wave shielding filter is a conductive material having a mesh shape pattern.

17. The display apparatus of claim 16, wherein the electromagnetic wave shielding filter comprises Cu, Ag, Al, Pt, Au, Fe, or an alloy of these metals.

18. The display apparatus of claim 16, wherein the electromagnetic wave shielding filter comprises a conductive ceramic material or carbon nanotubes.

19. The display apparatus of claim 1, wherein the base film comprises polymer resin.

20. The display apparatus of claim 1, wherein the base film comprises at least one selected from the group consisting of: Polyethersulfone (PES), Polyacrylate (PAC), Polyetherimides (PEI), Polyethylene Naphthalate (PEN), Polyethylene Terephthalate (PET), Polyphenylene Sulfide (PPS), Polyimide (PI), Polycarbonate (PC), Cellulous Triacetate (TAC) and Cellulose Acetate Propionate (CAP).
